(19) United States
(12) Patent Application Publication
(10) Pub. No.: US 2015/0350135 A1
(43) Pub. Date: Dec. 3, 2015

(54) INFORMATION PROCESSING APPARATUS, ELECTRONIC INFORMATION BOARD, STORAGE MEDIUM OF SOFTWARE PROGRAM, INFORMATION PROCESSING SYSTEM, AND ELECTRONIC INFORMATION BOARD SYSTEM

(71) Applicant: Hiroshi KATO, Kanagawa (JP)

(72) Inventor: Hiroshi KATO, Kanagawa (JP)

(73) Assignee: RICOH COMPANY, LTD., Tokyo (JP)

(21) Appl. No.: 14/713,395

(22) Filed: May 15, 2015

(30) Foreign Application Priority Data
May 28, 2014 (JP) 2014-109724
Apr. 15, 2015 (JP) 2015-083059

(51) Int. Cl. H04L 12/58

(52) U.S. Cl. CPC H04L 51/08; H04L 51/22

(57) ABSTRACT

An information processing apparatus includes a message receiver, an attachment data generator, an extractor, a message generator, and a message transmitter. The message receiver receives a message. The attachment data generator generates attachment data to be attached to a distribution message, to be transmitted from the information processing apparatus, by retrieving data loaded to the information processing apparatus. The extractor extracts candidate information to be used as transmission setting information of the distribution message from information included in the message received by the message receiver. The message generator generates the distribution message attachable with the attachment data generated by the attachment data generator based on the transmission setting information extracted by the extractor. The message transmitter transmits the distribution message generated by the message generator.

### CROSS-REFERENCE TO RELATED APPLICATION

This application claims priority pursuant to 35 U.S.C. §119(a) to Japanese Patent Application Nos. 2014-109724, filed on May 28, 2014 and 2015-083059, filed on Apr. 15, 2015 in the Japan Patent Office, the disclosure of which are incorporated by reference herein in their entirety.

### BACKGROUND

1. Technical Field

The present invention relates to an information processing apparatus, an electronic information board, a program, an information processing system, and an electronic information board system, and more particularly to an information processing apparatus, an electronic information board, a program, an information processing system, and an electronic information board system used for transmitting a message having data process able by the electronic information board.

2. Background Art

Electronic information boards that can display contents such as image data are used for meetings. The displayed image data can be printed by printers disposed for the electronic information boards, and can be stored to removable media attachable to the electronic information boards. Further, the displayed image data can be transmitted using electronic mails (e-mails) via network interfaces disposed for the electronic information boards.

However, when the displayed image data is transmitted from electronic information boards by generating the e-mails, users may need to perform troublesome operations on the electronic information boards. For example, users can select addresses of desired transmission destinations of e-mails from a database of address list stored in the electronic information board or external apparatus. However, if the users want to set a mail address not included in the address list as a transmission destination, the users have to input the concerned mail address to the electronic information board manually. Further, the users cannot set transmission senders of e-mails, but can set only a default mail address set for the electronic information board. Therefore, receivers of the e-mails may not identify the transmission senders of e-mails. Further, the users have to manually operate the electronic information boards to input titles and bodies of the e-mails. Therefore, the users have to perform troublesome operations for setting transmission settings of the e-mails.

### SUMMARY

As one aspect of the present invention, an information processing apparatus is devised. The information processing apparatus includes a message receiver to receive a message, an attachment data generator to generate attachment data to be attached to a distribution message, to be transmitted from the information processing apparatus, by retrieving data loaded to the information processing apparatus, an extractor to extract candidate information to be used as transmission setting information of the distribution message from information included in the message received by the message receiver, a message generator to generate the distribution message attachable with the attachment data generated by the attachment data generator based on the transmission setting information extracted by the extractor, and a message transmitter to transmit the distribution message generated by the message generator.

As another aspect of the present invention, a non-transitory computer-readable storage medium storing a program that, when executed by a computer, causes the computer to execute a method of processing information is devised. The method includes the steps of receiving a message, generating attachment data to be attached to a distribution message, to be transmitted from an information processing apparatus, by retrieving data loaded to an information processing apparatus, extracting candidate information to be used as transmission setting information of the distribution message based on the received message, generating the distribution message attachable with the generated attachment data based on the extracted transmission setting information, and transmitting the generated distribution message.

As another aspect of the present invention, an information processing system is devised. The information processing system includes an information processing apparatus, and an information terminal device including a message transmitter to transmit a message by designating a destination receivable by the information processing apparatus. The information processing apparatus includes a message receiver to receive the message transmitted from the message transmitter of the information terminal device, an attachment data generator to generate attachment data to be attached to a distribution message, to be transmitted from the information processing apparatus, by retrieving data loaded to an information processing apparatus, an extractor to extract candidate information to be used as transmission setting information of the distribution message from information included in the message received by the message receiver, a message generator to generate the distribution message attachable with the attachment data generated by the attachment data generator based on the transmission setting information extracted by the extractor, and a message transmitter to transmit the distribution message generated by the message generator.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a scheme of a network environment of a network system according to an example embodiments;

FIG. 2 is an example of a hardware configuration of an electronic information board in the network system of FIG. 1;

FIG. 3 is a functional bock diagram of the electronic information board of FIG. 2;

FIG. 4 is a chart showing sequences of receiving a distribution mail by a mobile device in the network system of FIG. 1;

FIG. 5 is an example of a screen of a display of the electronic information board displaying a two-dimensional code;

FIG. 6 is a flowchart showing the steps of a process of generating a distribution mail called at step S108 of FIG. 4;

FIG. 7A is an example of a GUI screen used for generating a distribution mail displayable on the display of electronic information board of FIG. 2;

FIG. 7B is an example of a GUI screen, transit from the GUI screen of FIG. 7A when a button for selecting transmission settings information from received mails is touched on the GUI screen of FIG. 7A;

FIG. 8 is an example of a GUI screen, transit from the GUI screen of FIG. 7A when a button for selecting transmission settings information from an address list is touched on the GUI screen of FIG. 7A;

FIGS. 9A and 9B are a flowchart showing the steps of a process of generating a distribution mail called at step S203 of FIG. 6;

FIG. 10 is a sequential chart of a use environment of the electronic information board of FIG. 2;

FIG. 11 is a flowchart showing the steps of a process of deleting a mail by the electronic information board of FIG. 2;

FIG. 12 is a sequential chart of receiving a distribution mail by a mobile device in a network system according to another example embodiment of;

FIGS. 13A, 13B, and 13C are examples of screens displayed on an electronic information board according to another example embodiment of; and

FIG. 14 is an example of a screen displayable on a mobile device that has received a mail address from the electronic information board in the network system of FIG. 12.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more example embodiments are described hereinafter.

A description is now given of an information processing apparatus and an information processing system according to one or more example embodiments, but it should be noted that the information processing apparatus and the information processing system are not limited to the following example embodiments. In this description, an electronic information board is described as one example of the information processing apparatus including a display apparatus and an input apparatus, and further, a network system having an electronic information board and a mobile device or portable device is described as one example of the information processing system having an information processing apparatus and an information terminal device. The mobile device or portable device is described as one example of the information terminal device.

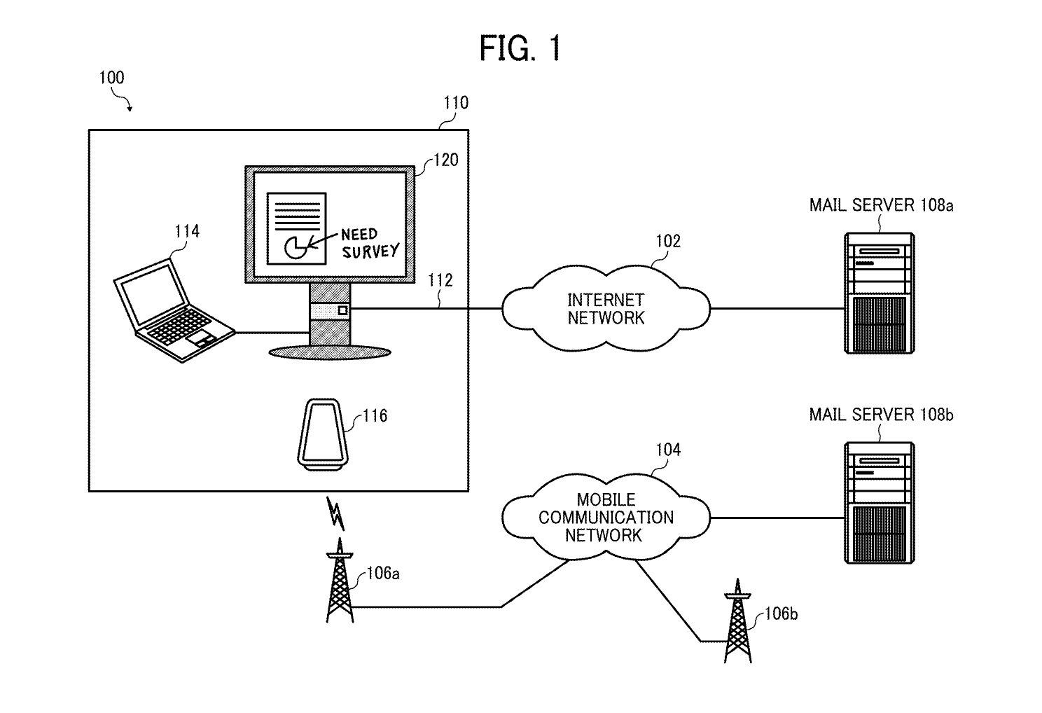

FIG. 1 is a scheme of a network environment of a network system 100 according to one or more example embodiments. In the network environment of FIG. 1, the network system 100 includes, for example, an Internet network 102, and a mobile communication network 104. The Internet network 102 is a public network, which can be connected by transmission control protocol/Internet protocol (TCP/IP). The mobile communication network 104 is typically a carrier network such as 3G (third generation mobile wireless telecommunications systems), LTE (Long Term Evolution), WIMAX (registered trademark), WIMAX2 (registered trademark) or the like. The Internet network 102 and the mobile communication network 104 can be connected by a gateway.

Various servers such as a mail server 108a and a web server may exist on the Internet network 102, and various servers such as a mail server 108b, and base stations 106a and 106b may exist on the mobile communication network 104.

In the network environment illustrated in FIG. 1, an electronic information board 120 is disposed at a location 110, wherein the location 110 can be various organizations such as government agencies, universities, companies, and homes but not limited thereto. Further, a network 112 such as a local area network (LAN) disposed at the location 110 can be connected to the Internet network 102 via a router.

Therefore, the electronic information board 120 can be connected to the Internet network 102, and can communicate with the mail server 108a on the Internet network 102. The electronic information board 120 can be operated as a standalone apparatus, in which the electronic information board 120 can display file images stored in the electronic information board 120. Further, the electronic information board 120 can be operated as an apparatus connected to a terminal apparatus 114, and the electronic information board 120 can display images such as movie images and still images received from the terminal apparatus 114.

As illustrated in FIG. 1, a mobile device 116 (information terminal device) may exist at the location 110. The mobile device 116 can communicate with a nearby base station such as the base station 106a so that the mobile device 116 can be connected with the mobile communication network 104, with which the mobile device 116 can communicate with the mail server 108b on the mobile communication network 104. The mobile device 116 is, for example, smart phones, tablets, personal digital assistance (PDA), and feature phones, but not limited thereto.

When a user does not have a device that can directly communicate with the electronic information board 120, the user may want to acquire data displayed on the electronic information board 120 by using an electronic mail (e-mail). In this situation, the data displayed on the electronic information board 120 can be retrieved and attached to an e-mail, and the e-mail can be delivered or transmitted to a desired destination. If an address list is stored in the electronic information board 120, an address of the desired destination can be selected from the address list. However, there is a demand of delivering or transmitting e-mails to one or more users not registered in databases of organizations and/or the address list in the electronic information board 120. In this case, a manual input operation of unregistered address (i.e., destination address) to the electronic information board 120 is required. Since the manual input operation is troublesome for users, it is desired to set transmission settings including destination address of e-mails with a simple method. Further, other than setting the destination, the manual input operation is troublesome for users when registering transmission senders, and inputting title and body of e-mails,

Therefore, as to the one or more example embodiments of the present invention, a user who wants to receive data displayed on a screen of the electronic information board 120 transmits an e-mail to the electronic information board 120 by using the mobile device 116 carried by the user. Upon receiving the e-mail, the electronic information board 120 accumulates the e-mail. Then, the electronic information board 120 generates an e-mail (distribution mail) by attaching the data displayed on the screen, sets transmission settings of the e-mail (distribution mail) based on information of the accumulated e-mail, and transmits the e-mail (distribution mail). With this configuration, candidate information of transmission settings can be extracted based on the information of the received e-mail, and thereby an input operations by users for setting communication settings such as transmission settings of e-mails on the electronic information board 120 can be reduced.

As to the network environment of FIG. 1, the electronic information board 120 can be set with transmission and reception settings of e-mail account managed by the mail server 108a on the Internet network 102. Further, it is assumed that the mobile device 116 has an e-mail account on the mail server 108b of the mobile communication network 104. An e-mail transmitted from the mobile device 116 to the electronic information board 120 is transmitted to the mail server 108b on the mobile communication network 104, and transferred to the mail server 108a by a mail transfer between the mail servers 108a and 108b, and then transmitted to the mail server 108a that manages an account of a destination of the e-mail.

The electronic information board 120 performs a mail reception process periodically to receive e-mails transferred to the mail server 108a and addressed to the electronic information board 120. Upon receiving the e-mails, the electronic information board 120 accumulates the e-mails, with which information included in the e-mails can be used as candidate information for setting transmission settings of a distribution mail to be transmitted from the electronic information board 120.

Further, the network environment including the Internet network 102 and the mobile communication network 104 shown in FIG. 1 is one example that the mobile device 116 cannot communicate with the electronic information board 120 directly, but the configuration of the network environment is not limited hereto.

The e-mail delivered or transmitted by an e-mail system is one example of the message, but the message can be others such as instant message (IM) delivered or transmitted by an instant messaging system.

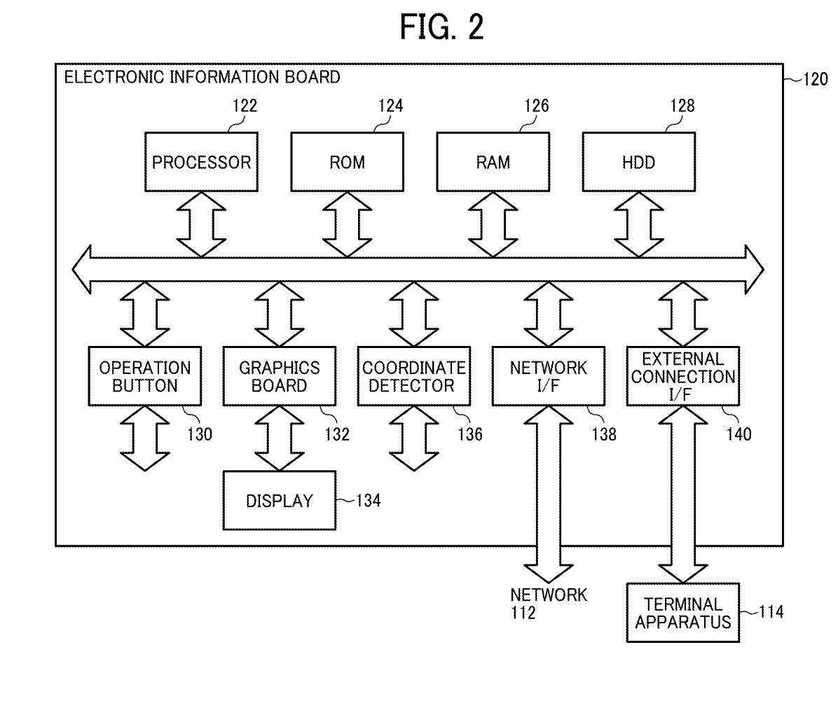

A description is given of a hardware configuration of the electronic information board 120. FIG. 2 is an example of a hardware configuration of the electronic information board 120 according to one or more example embodiments. As illustrated in FIG. 2, the electronic information board 120 includes, for example, a processor 122, a read only memory (ROM) 124, a random access memory (RAM) 126, a hard disk drive (HDD) 128, an operation button 130, a graphics board 132, a display 134, a coordinate detector 136, a network interface (I/F) 138, and an external connection interface (I/F) 140.

The processor 122 is a computing device that controls various processing performable by the electronic information board 120. The processor 122 can be a central processing unit (CPU) or a micro processing unit (MPU) employing various processors such as PENTIUM (registered trademark). The ROM 124 is a non-volatile memory that stores a boot program such as basic input/output system (BIOS) and others.

The RAM 126 is a volatile memory or a non-volatile memory used as a working area of software program executable by the processor 122. Under the management of an operating system (OS), the processor 122 executes object-oriented programming languages such as C, C++, Java (registered trademark), JavaScript (registered trademark), Perl, Ruby, Python, or legacy programming languages such as machine language, assembler language to control functional units of the electronic information board 120 to be described later.

The HDD128 is a non-volatile memory of large capacity, which stores various operating systems (OS) such as WINDOWS (registered trademark), UNIX (registered trademark), LINUX (registered trademark), and Android (registered trademark) used for controlling the entire system of the electronic information board 120. Further, the HDD128 stores various data such as device drivers of the graphics board 132, the display 134, and the coordinate detector 136, and software programs for main processing. The software program can be stored in computer-readable storage medium such as a compact disk read only memory (CD-ROM), a compact disk rewritable (CD-RW), a digital versatile disk read only memory (DVD-ROM), DVD recording only/rewritable (DVD-R/RW), a flexible disk, electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, and the software program can be installed to the electronic information board 120. Further, the software program can be installed to the electronic information board 120 via a network.

The operation button 130 is one or more hardware buttons disposed on an outer face of a casing of the electronic information board 120, which are operable by users. The graphics board 132 is a processing circuit that processes data drawn on the display 134, and can be configured with, for example, a video RAM (VRAM) that retains video image, and image connection terminals connectable to the display 134. The display 134 is a display apparatus that displays data drawn or generated by the graphics board 132.

The coordinate detector 136 is a detector that detects an object such as a pen and/or a finger contacting or coming close to the display 134. The coordinate detector 136 can be a touch panel having a capacitive sensor that detects capacitance that is changed by a contact of the object, or a touch panel having a pressure sensor that detects contact pressure of the object. Further, the coordinate detector 136 can be an optical detector that detects blocking of light, emitted in parallel along a face of the display 134 from one direction or two directions (height and length directions) to detect contacting or coming close of the object to the display 134.

The network interface 138 is an interface that connects the electronic information board 120 to the network 112, and can be a physical interface such as a local area network (LAN) cable connector, a modular cable connector or the like. The external connection I/F 140 is an interface that connects the terminal apparatus 114 such as personal computers to the electronic information board 120, and can be a physical interface such as a video graphics array (VGA) input connector, a high-definition multimedia interface (HDMI: registered trademark) port, a universal serial bus (USB) port or the like. For example, a plurality of terminal apparatuses 114 can be connected to the external connection I/F 140. Further, the terminal apparatus 114 can be connected to the electronic information board 120 wirelessly using WiFi (registered trademark) or the like.

As to the hardware configuration shown in FIG. 2, the information processing apparatus such as the electronic information board 120 includes a display apparatus such as the display 134, an input apparatus such as the operation button 130 and the coordinate detector 136, and a computing apparatus in the same casing. However, the hardware configuration of the electronic information board 120 is not limited hereto. In another configuration, an electronic information board system can be configured with a plurality of apparatuses connected with each other such as a display apparatus, an input apparatus, and a computing apparatus, which are independent apparatuses mutually. Further, the information processing apparatus can be a projector including a display apparatus, an input apparatus, a network interface that can write images by using an electronic pen, or any types of apparatus that can be connected.

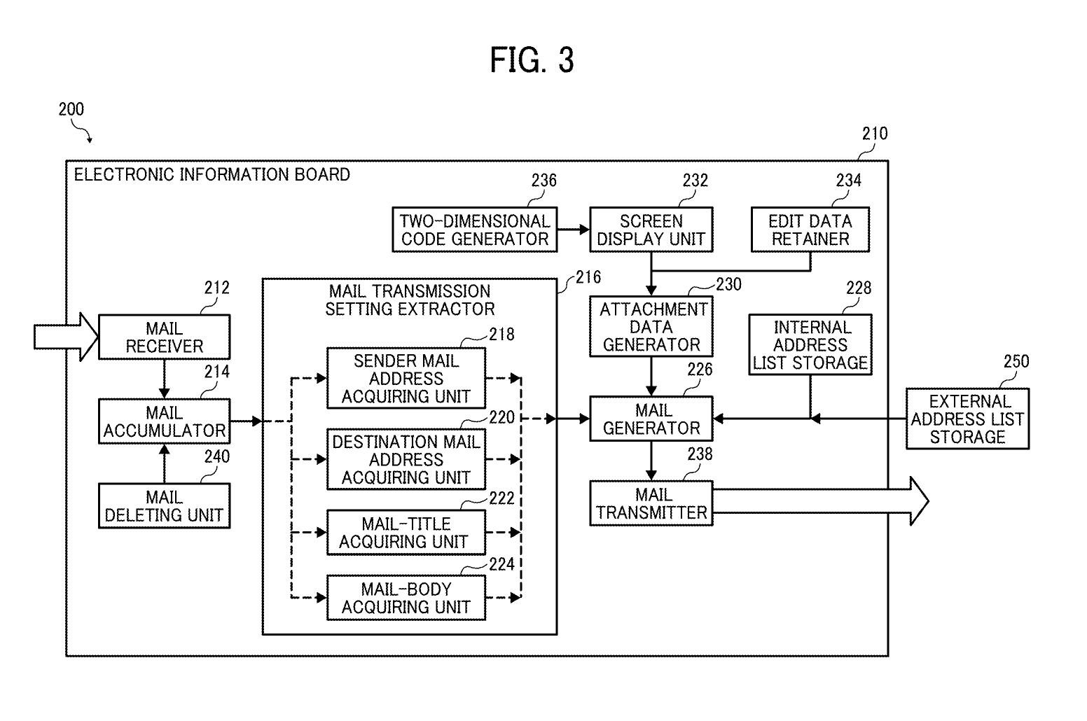

A description is given of a functional configuration (hereinafter, functional block 200) of the system including the electronic information board 120 as a main apparatus with reference to FIG. 3. FIG. 3 is a functional bock diagram of the electronic information board 120.

As illustrated in FIG. 3, a functional block 210 of the electronic information board 120 includes, for example, a mail receiver 212, a mail accumulator 214, a mail transmission setting extractor 216, a mail generator 226, an internal address list storage 228, an attachment data generator 230, a screen display unit 232, an edit data retainer 234, a two-dimensional code generator 236, and a mail transmitter 238.

Based on pre-set reception settings of mail such as e-mail, the mail receiver 212 communicates with the mail server 108a used as a mail receiving server, and performs a mail receiving process of the e-mail account set to the electronic information board 120. The mail receiver 212 performs the mail receiving process of the e-mail transmitted to the account of the mail receiver 212 using a given protocol such as POP3 (Post Office Protocol version 3), IMAP (Internet Message Access Protocol) or the like. The mail receiver 212 can be used as a message receiver according to one or more example embodiments. The mail accumulator 214 can be implemented by a storage or memory such as the RAM 126 and/or the HDD 128 to accumulate e-mails received by the mail receiver 212. The mail accumulator 214 can be used as an accumulator according to one or more example embodiments.

Based on the received and accumulated e-mails (hereinafter, referred to accumulated mails), the mail transmission setting extractor 216 extracts settings information, which can be used as candidate information of transmission settings of an e-mail (hereinafter, distribution mail) to be transmitted from the electronic information board 120, in which the distribution mail can be attached with data displayed on the screen of the electronic information board 120 by retrieving the data.

The mail transmission setting extractor 216 includes, an extraction unit that extracts at least transmission sender information, transmission destination information, title information, and body information of the accumulated mails. The mail transmission setting extractor 216 can be used as an extractor according to one or more example embodiments. More specifically, the mail transmission setting extractor 216 includes, for example, a sender mail address acquiring unit 218, a destination mail address acquiring unit 220, a mail-title acquiring unit 222, and a mail-body acquiring unit 224.

The sender mail address acquiring unit 218 extracts information of the transmission sender (“from” field) from the accumulated mails to use the extracted information as transmission destination (“to, cc, bcc” field), transmission sender (“from” field), and reply-destination (“reply-to” field) of the distribution mail. The destination mail address acquiring unit 220 extracts information of the transmission destination (“to” field, “cc” field) from the accumulated mails to use the extracted information as transmission destination, transmission sender, and reply-destination of the distribution mail. The mail-title acquiring unit 222 extracts the title information from the accumulated mails to use the extracted title information as a title of the distribution mail. The mail-body acquiring unit 224 extracts the body information from the accumulated mails to use the extracted body information as a body of the distribution mail.

In this configuration, address information to be used as information of transmission destination, transmission sender and/or reply-destination of the distribution mail can be acquired from information of transmission sender and transmission destination included in the accumulated mails with a simplified process. Further, in another configuration, an e-mail address can be included in a body of mail, in which address information can be extracted from the body by analyzing the body.

The screen display unit 232 is used as a display controller that controls a screen image displayable on the display 134 of the electronic information board 120. The screen display unit 232 performs a display control of various images such as images generated by replaying files stored in the electronic information board 120, images input from the terminal apparatus 114, and strokes input to the electronic information board 120 by an input apparatus such as a touch pen or the like. The screen display unit 232 retains image data displayed on the display 134 of the electronic information board 120. Further, the edit data retainer 234 retains input data (e.g., strokes, text string, marker) input to the electronic information board 120 by using the input apparatus such as the touch panel. Further, the input data is not limited to strokes, text string, and marker, but the input data can include multi-media data such as audio data such as audio input signals recorded by the electronic information board 120.

The attachment data generator 230 retrieves data displayed on the screen (display 134) of the electronic information board 120 to generate attachment data to be attached to a distribution mail. The attachment data generator 230 can be used as an attachment data generator according to one or more example embodiments. The attachment data generator 230 converts image data displayed on the screen (display 134) by the screen display unit 232, and the input data input to the screen (display 134) by the input apparatus such as the touch panel into data having a given format such as still image format, or movie image format to generate an attachment file.

In this configuration, data retrieved from the screen can be attached to an e-mail as attachment data. Further, in another configuration, data generated from the retrieved data displayed on the screen can be uploaded to a document management system or a file management server, and a storage destination path of the data is generated as attachment data, and the attachment data is attached to a distribution mail.

Based on settings information extracted by the mail transmission setting extractor 216, the mail generator 226 generates a distribution mail attached with the attachment data generated by the attachment data generator 230. Based on the extracted settings information, the mail generator 226 can set at least one of transmission sender, transmission destination, reply-destination, title, and body of the distribution mail based on a selection operation by a user.

The internal address list storage 228 such as a memory retains information of e-mail address registered in the electronic information board 120 in advance. Further, the electronic information board 120 of FIG. 3 can communicate with an external database such as an external address list storage 250 such as a memory that is includable in the overall functional block 200. Therefore, the transmission sender, transmission destination, and reply-destination of a distribution mail can be selected from the address list stored in the internal address list storage 228 and/or the external address list storage 250.

Based on pre-set transmission settings of e-mail, the mail transmitter 238 can communicate with the mail server 108a used as a mail transmission server to perform a mail transmission process of the distribution mail generated by the mail generator 226. The mail transmitter 238 transmits the distribution mail generated by the mail generator 226 using a protocol such as simple message transfer protocol (SMTP). The mail transmitter 238 can be used as a message transmitter according to one or more example embodiments. In this configuration, an address determined as a transmission sender can be set as a transmission sender (“from” field) of the distribution mail, in which it is assumed that the distribution mail is transmitted from the set mail account (transmission sender) in appearance.

The two-dimensional code generator 236 generates a two-dimensional code embedded with a mail address of destination that is receivable by the electronic information board 120. The two-dimensional code generator 236 can be used as an image information generator according to one or more example embodiments.

The screen display unit 232 displays the two-dimensional code generated by the two-dimensional code generator 236 on the screen (display 134). The screen display unit 232 can be used as an output unit according to one or more example embodiments. Although the two-dimensional code such as QR code (registered trademark) can be used as image information, the image information is not limited hereto. For example, a bar code or other codes can be employed as the image information.

The functional block 200 of the electronic information board 120 can further include a mail deleting unit 240. The mail deleting unit 240 can be used as a deleting unit that deletes one or more mails accumulated in the mail accumulator 214 when an event occurs. For example, it is not preferable to store information of the received mails for a long time from the viewpoint of information security. Therefore, it can be configured to delete the accumulated mails used one or more times for transmitting the distribution mails. Further, it can be configured to set a time limit for retaining the accumulated mails. The mail deleting process will be described later in detail.

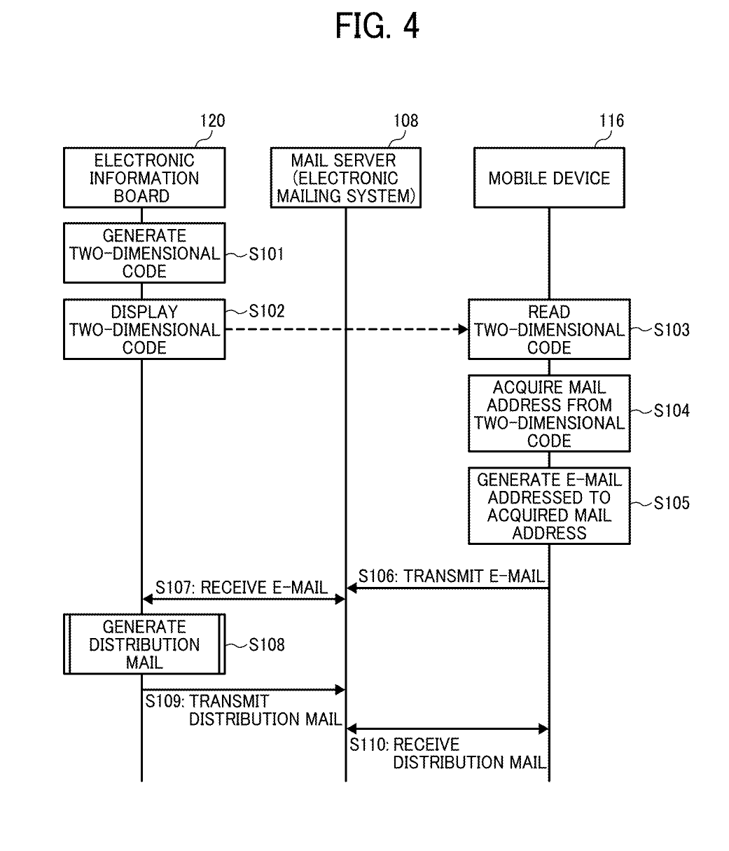

A description is given of a transmission process of a distribution mail according to one or more example embodiments with reference to FIGS. 4 to 9. FIG. 4 is a chart showing sequences of receiving a distribution mail by a mobile device in the network system 100.

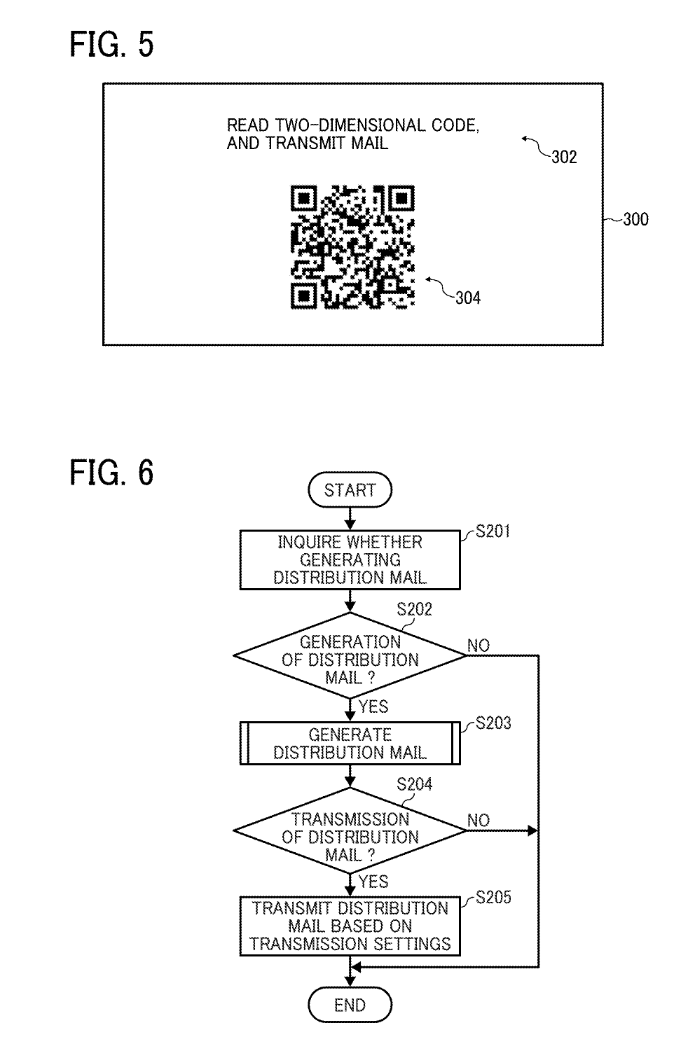

The sequence of FIG. 4 proceeds as follows. At step S101, the two-dimensional code generator 236 of the electronic information board 120 generates a two-dimensional code (FIG. 5) embedded with a coded mail address of the electronic information board 120. At step S102, the screen display unit 232 of the electronic information board 120 displays the generated two-dimensional code on of the display 134 of the electronic information board 120.

FIG. 5 is an example of a screen image of the display 134 of the electronic information board 120 displaying a two-dimensional code. For example, the electronic information board 120 displays a two-dimensional code display screen 300 shown in FIG. 5 in response to a user's operation such as a press of a button used for displaying the two-dimensional code. The two-dimensional code display screen 300 includes, for example, a message 302 that instructs a reading of the two-dimensional code, and a two-dimensional code image 304.

Referring back to FIG. 4, when the two-dimensional code display screen 300 is displayed (S102), at step S103, a user operates the mobile device 116 to read the two-dimensional code. For example, a two-dimensional code reader application is activated by the user, and then the two-dimensional code reader reads the two-dimensional code image displayed on the electronic information board 120, in which the two-dimensional code image 304 can be captured by a camera of the mobile device 116. The two-dimensional code reader can be used a reader according to one or more example embodiments. At step S104, the mobile device 116 analyzes the read two-dimensional code to acquire mail address information. At step S105, the mobile device 116 generates an e-mail by setting the acquired mail address as a destination. At step S106, the mobile device 116 transmits the generated e-mail to the mail server 108b by using a mail transmitter of the mobile device 116. Then, the e-mail is transferred from the mail server 108b (mail transmission server) for the mobile device 116 to the mail server 108a used for a destination side. The e-mail can include information that a user is to use on the electronic information board 120. At step S107, the electronic information board 120 communicates with the mail server 108a to receive the e-mail addressed to the mail address of the electronic information board 120.

At step S108, the electronic information board 120 calls a generation process of a distribution mail. For example, the electronic information board 120 can be configured to call a generation screen of distribution mail, and a generation process of the distribution mail using the generation screen upon receiving the e-mail. For example, a balloon image can be pop-upped and displayed on the screen upon receiving the e-mail to notify a reception of the e-mail to a user, and then a touching operation to the balloon image is detected to display the generation screen of the distribution mail. The balloon image can be used as an example of a calling unit of a mail generation according to one or more example embodiments.

At step S109, the mail transmitter 238 of the electronic information board 120 performs a mail transmission process to the mail server 108. In this case, it is assumed that the distribution mail is transmitted to the mobile device 116 (destination), which has transmitted the e-mail, and the distribution mail is transferred from the mail server 108a (mail transmission server) disposed for the electronic information board 120 to the mail server 108b disposed for the mobile device 116 (destination). At step S110, the mobile device 116 communicates with the mail server 108b to receive the distribution mail including attachment data addressed to the mail address of the mobile device 116.

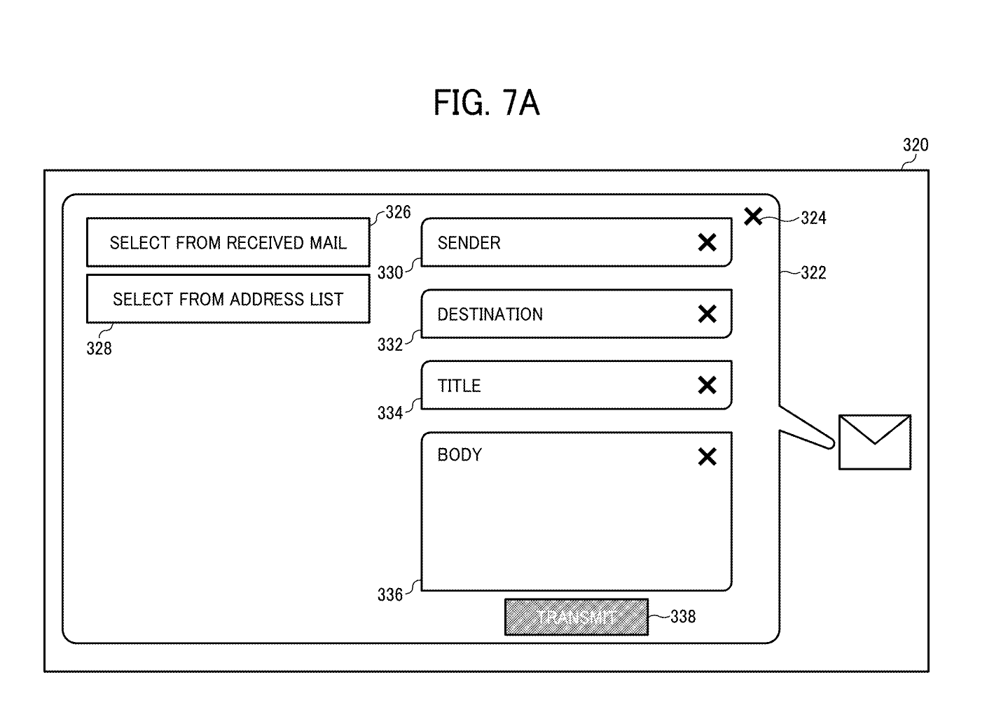

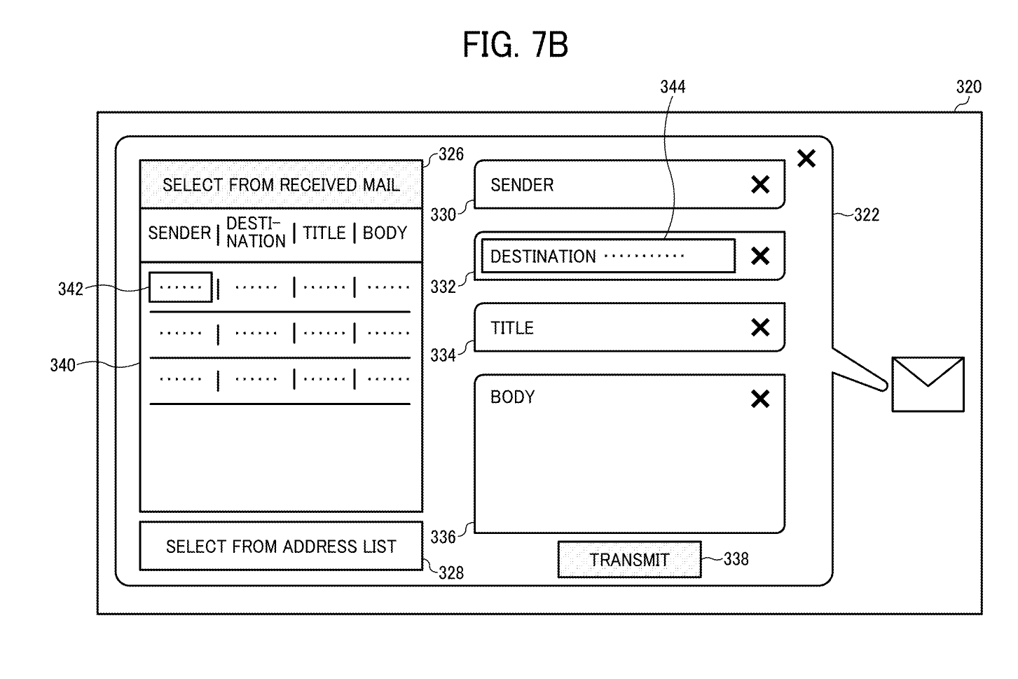

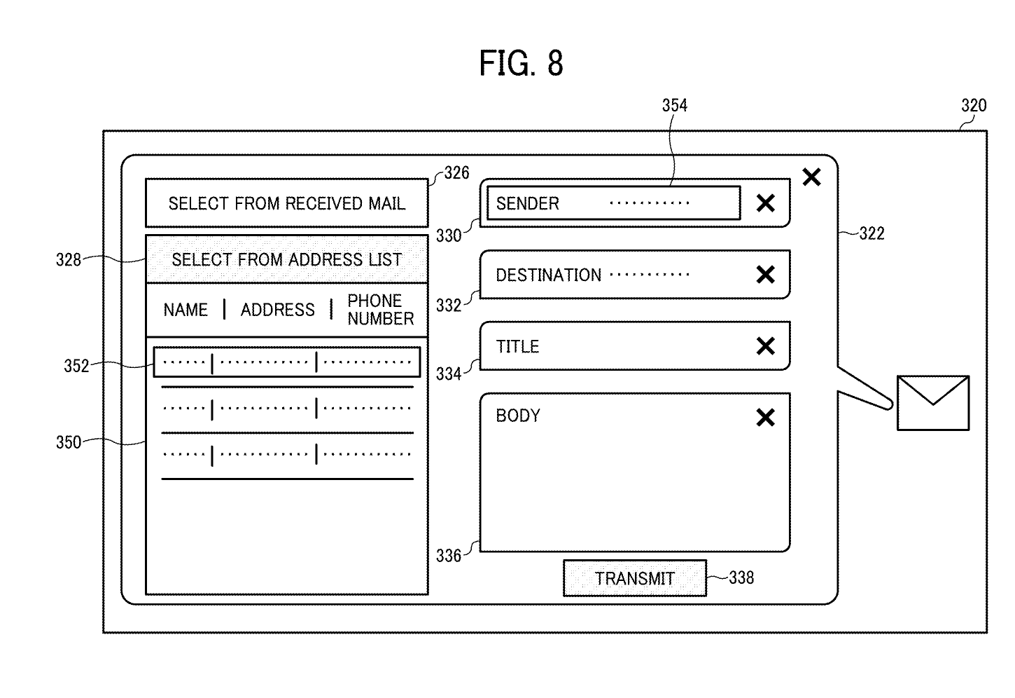

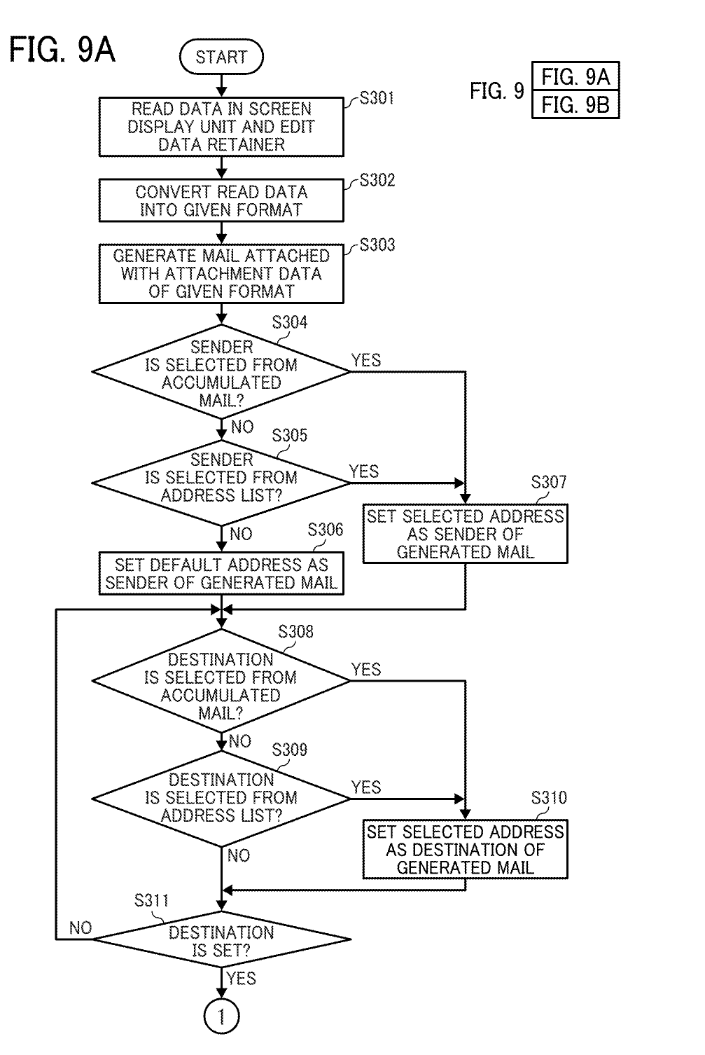

FIG. 6 is a flowchart showing the steps of a process of generating a distribution mail, which can be called at step S108 of FIG. 4. FIGS. 7 and 8 are examples of graphical user interface (GUI) screens, used for a transmission process of a distribution mail, displayable on the display 134 of the electronic information board 120.

The sequence of FIG. 6 is activated when the electronic information board 120 receives an e-mail, which can be called at step S108 of FIG. 4. At step S201, the electronic information board 120 inquires a user whether a distribution mail is to be generated. For example, an object such as a balloon image is pop-upped and displayed on the display 134 to inform or notify a reception and accumulation of the e-mail and to inquire whether a distribution mail is to be generated based on the accumulated e-mail. At step S202, the electronic information board 120 determines whether a generation of the distribution mail is instructed.

At step S202, when a cancel button in the balloon image (e.g., button “x” set at a corner of the balloon image) is touched, or a given time period elapses after displaying the balloon image, an instruction not to proceed to the transmission process of the distribution mail is set explicitly or implicitly (S202: NO), and then the sequence is completed. By contrast, at step S202, when the balloon image (pop-upped object) is touched, an instruction to proceed to the transmission process of the distribution mail is set (S202: YES), and the sequence proceeds to step S203. At step S203, the GUI screens illustrated in FIGS. 7 and 8 are displayed to call a generation process of a distribution mail.

FIG. 7A is an example of a start screen used for generating a distribution mail, which is displayable on the display 134 of the electronic information board 120. A GUI screen 320 illustrated in FIG. 7A includes a setting screen 322 used for inputting transmission settings of a distribution mail. The setting screen 322 includes, for example, a button 326, a button 328, a transmission-sender input field 330, a transmission-destination input field 332, a title input field 334, a body input field 336, a transmission button 338, and a cancel button 324. The button 326 is used to select settings information from the received mails. The button 328 is used to select settings information from the address list accessible from the electronic information board 120. The button 328 can be used as an example of a selection unit according to one or more example embodiments. The transmission-sender input field 330 is used to input a transmission sender. The transmission-destination input field 332 is used to input a transmission destination. The title input field 334 is used to input a title. The body input field 336 is used to input a body. The transmission button 338 is used to instruct a transmission process. The cancel button 324 is used to cancel a transmission process.

FIG. 7B is an example of a GUI screen, transit from the start screen of FIG. 7A when the button 326 (i.e., a button for selecting settings information from the received mails) is touched on the start screen of FIG. 7A. In the GUI screen 320 of FIG. 7B, a table 340 is displayed below the button 326 to display a list of e-mails that are accumulated at current time. Information such as sender, destination, title and body displayed in the table 340 can be extracted from the accumulated mails by the mail transmission setting extractor 216. Further, by setting the login authentication of users of the electronic information board 120, a user access right to the accumulated mails can be restricted.

Based on the GUI screen 320 of FIG. 7B, a sender and a destination can be set as follows. For example, by selecting a sender from the received accumulated mail, and then selecting a transmission sender of a generating distribution mail, the sender of the accumulated mail can be set as the transmission sender of the generating distribution mail. For example, by selecting a sender from the accumulated mail, and then selecting a transmission destination of a generating distribution mail, the sender of the accumulated mail can be set as the transmission destination of the generating distribution mail. For example, by selecting a destination from the accumulated mail, and then selecting a transmission sender of a generating distribution mail, the destination of the accumulated mail can be set as the transmission sender of the generating distribution mail. For example, by selecting a destination from the accumulated mail, and then selecting a transmission destination of a generating distribution mail, the destination of the accumulated mail can be set as the transmission destination of the generating the distribution mail. For example, the destination of the accumulated mail can be a destination (“to” field, “cc” field) used with a mail address of the electronic information board 120. Further, if a plurality of destinations exist, a GUI that can select one destination from the plurality of destinations can be set.

Further, a title and a body can be set as follows. For example, by selecting a title from the accumulated mail, and then selecting a title of a generating distribution mail, the title of the accumulated mail (received e-mail) can be set as the title of the generating distribution mail without change. For example, by selecting a body from the accumulated mail, and then selecting a body of a generating distribution mail, the body of the accumulated mail (received e-mail) can be set as the body of the generating distribution mail without change.

FIG. 7B shows one status that the transmission-destination input field 332 is selected, and further a sender 342 of the first accumulated mail is selected from the e-mail list in the table 340. Therefore, this case indicates that the sender 342 of the first accumulated mail is selected as a transmission destination 344 of a distribution mail. Further, a mail that is used as an initiator to call a generation process of the distribution mail, and an accumulated mail used for setting communication settings such as transmission settings can be the same mail or different mails.

FIG. 8 is an example of a GUI screen, transit from the start screen of FIG. 7A when the button 328 (i.e., a button for selecting settings information from the address list) is touched on the start screen of FIG. 7A. In the GUI screen 320 of FIG. 8, a table 350 is displayed below the button 328 to display an entry list registered in the address list. FIG. 8 shows one status that the transmission-sender input field 330 is selected, and further a first entry 352 is selected from the entry list in the table 350. Therefore, this case indicates that the first entry 352 of the address list is selected as a sender 354 of a distribution mail.

Referring back to FIG. 6, at step S204, it is determined whether a transmission process of the distribution mail is instructed. Specifically, if the transmission button 338 is touched on the GUI screen 320 shown in FIGS. 7 and 8, it is determined that the transmission is instructed (S204: YES), and then the sequence proceeds to step S205. At step S205, the mail transmitter 238 of the electronic information board 120 performs a transmission process of the distribution mail based on the determined communication settings such as transmission settings, and then the sequence is completed.

By contrast, if it is determined that a cancel of transmission of the distribution mail is instructed (S204: NO), the sequence is completed. For example, if the cancel button 324 is touched on the GUI screen 320 shown in FIGS. 7 and 8, a cancel of transmission of the distribution mail is instructed.

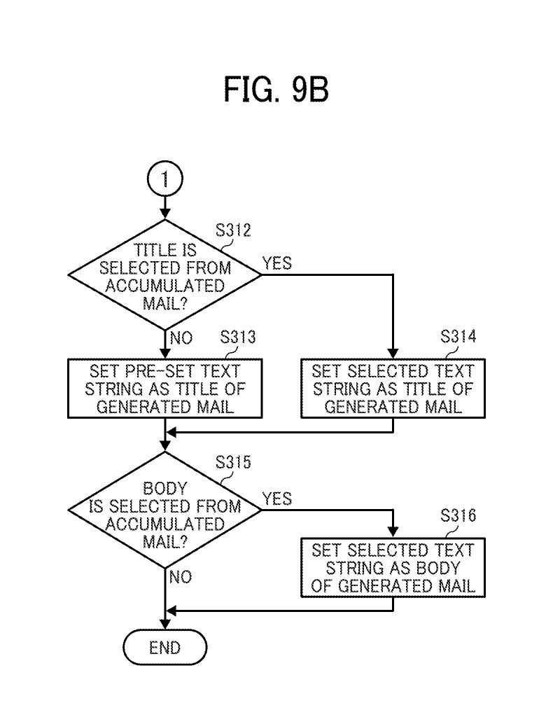

FIGS. 9A and 9B are a flowchart showing the steps of a process of generating a distribution mail. The sequence of FIG. 9 can be called at step S203 of FIG. 6. At step S301, the attachment data generator 230 of the electronic information board 120 reads data such as image data and input data retained in the screen display unit 232 and the edit data retainer 234.

At step S302, the attachment data generator 230 of the electronic information board 120 converts the read data such as image data and input data into data having a given format. For example, image data displayed on the screen of the electronic information board 120, and data drawn on the screen such as strokes input to the screen of the electronic information board 120 can be collectively superimposed to generate image data to be used as attachment data.

At step S303, the mail generator 226 of the electronic information board 120 newly generates a distribution mail (e-mail) attached with the attachment data having the given format generated at step S302. At steps S304 to S316, transmission settings of the newly generated distribution mail is performed based on information input to the input fields of the GUI screens shown in FIGS. 7 and 8.

At step S304, the mail generator 226 of the electronic information board 120 determines whether a transmission sender is selected from the accumulated mails. If it is determined that the transmission sender is not selected from the accumulated mails (S304: NO), the sequence proceeds to step S305. At step S305, the mail generator 226 of the electronic information board 120 determines whether the transmission sender is selected from the address list. If it is determined that the transmission sender is not selected from the address list (S305: NO), the sequence proceeds to step S306.

At step S306, since the transmission sender is not selected from the accumulated mail and the address list, the electronic information board 120 sets a default mail address as the transmission sender of the newly generated distribution mail, in which the default mail address is a pre-set address such as a mail address assigned to the electronic information board 120 or an administrator mail address, and the sequence proceeds to step S308.

By contrast, if it is determined that the transmission sender is selected from the accumulated mail (S304: YES), the sequence proceeds to step S307. At step S307, the mail generator 226 of the electronic information board 120 sets an address selected from the accumulated mails as the transmission sender of the newly generated distribution mail, and the sequence proceeds to step S308.

Further, if it is determined that the transmission sender is selected from the address list (S305: YES), the sequence proceeds to step S307. At step S307, the mail generator 226 of the electronic information board 120 sets an address selected from the address list as the transmission sender of the newly generated distribution mail, and the sequence proceeds to step S308.

At step S308, the mail generator 226 of the electronic information board 120 determines whether the transmission destination is selected from the accumulated mail. If it is determined that the transmission destination is selected from the accumulated mail (S308: YES), the sequence proceeds to step S310. At step S310, the mail generator 226 of the electronic information board 120 sets an address selected from the accumulated mails as the transmission destination of the newly generated distribution mail, and the sequence proceeds to step S311.

By contrast, if it is determined that the transmission destination is not selected from the accumulated mail (S308: NO), the sequence proceeds to step S309. At step S309, the mail generator 226 of the electronic information board 120 determines whether the transmission destination is selected from the address list. If it is determined that the transmission destination is selected from the address list (S309: YES), the sequence proceeds to step S310. At step S310, an address selected from the address list is set as the transmission destination of the newly generated distribution mail, and the sequence proceeds to step S311.

If it is determined that the transmission destination is not selected from the address list (S309: NO), the sequence proceeds to step S311. At step S311, the mail generator 226 of the electronic information board 120 determines whether the transmission destination is set. If it is determined that the transmission destination is not yet set (S311: NO), the sequence returns to step S308 to request a setting of transmission destination. This is conducted because a default address can be used as transmission sender, and a title and a body can be set blank or standard, routine, pre-set, or fixed text string, but at least the transmission destination is required to be designated when transmitting the e-mail.

By contrast, if it is determined that the transmission destination is set (S311: YES), the sequence proceeds to step S312. In this configuration, if the transmission destination is selected from the accumulated mail, selected from the address list, or is input manually, the sequence proceeds to step S312.

At step S312, the mail generator 226 of the electronic information board 120 determines whether a title is selected from the accumulated mails. If it is determined that the title is not selected from the accumulated mails (S312: NO), the sequence proceeds to step S313. At step S313, the mail generator 226 of the electronic information board 120 sets standard, routine, pre-set, or fixed text string as the title of the newly generated mail, and the sequence proceeds to step S315. The standard, routine, pre-set, or fixed text string can be “no title”, “text string having date information,” or the like. Further, if the title is input manually, the manually input text string can be used. By contrast, if it is determined that the title is selected from the accumulated mails (S312: YES), the sequence proceeds to step S314. At step S314, the mail generator 226 of the electronic information board 120 sets the selected text string as the title of the newly generated mail, and the sequence proceeds to step S315.

At step S315, the mail generator 226 of the electronic information board 120 determines whether a body is selected from the accumulated mails. If it is determined that the body is not selected from the accumulated mails (S315: NO), the sequence is completed without no description (i.e., body is remained blank). Further, if the body is input manually, the manually input text string can be used as the body. By contrast, if it is determined that the body is selected from the accumulated mails (S315: YES), the sequence proceeds to step S316. At step S316, the mail generator 226 of the electronic information board 120 sets the selected text string as the body of the newly generated mail, and the sequence is completed.

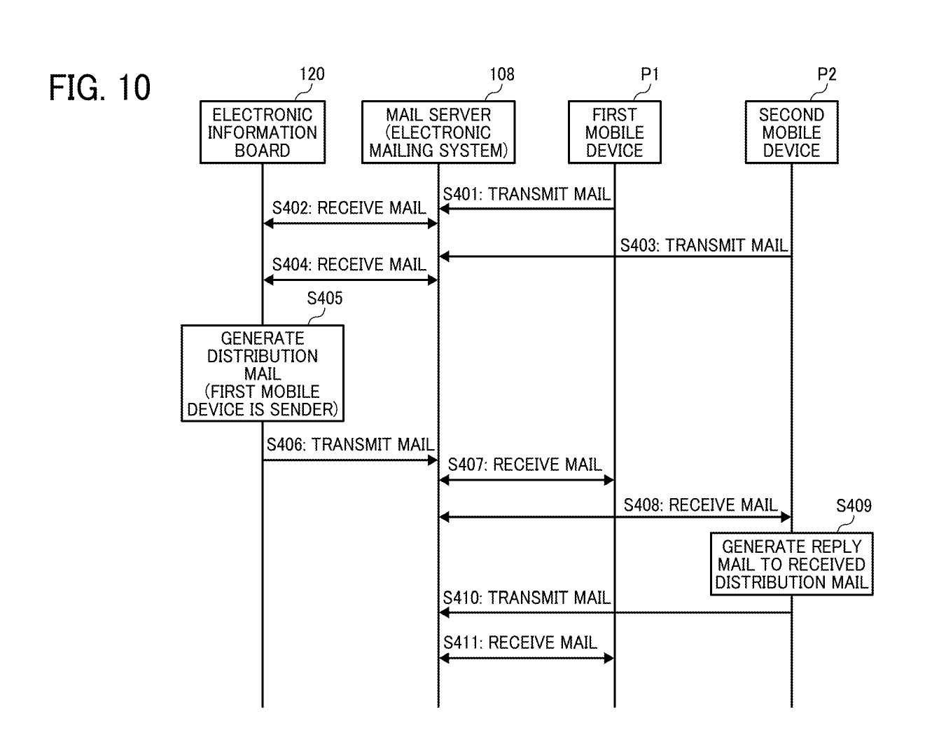

A description is given of a use environment of the electronic information board 120 with reference to FIG. 10. FIG. 10 is a sequential chart of a use environment of the electronic information board 120, in which two mobile devices are used.

At step S401, a first mobile device P1 transmits an e-mail addressed to the electronic information board 120. At step S402, the electronic information board 120 communicates with the mail server 108 to receive the e-mail from the first mobile device P1 addressed to the mail address of the electronic information board 120. Similarly, at step S403, a second mobile device P2 transmits an e-mail addressed to the electronic information board 120. At step S404, the electronic information board 120 communicates with the mail server 108 to receive the e-mail from the second mobile device P2 addressed to the mail address of the electronic information board 120.

At step S405, the electronic information board 120 generates a distribution mail. In this example case, a distribution mail is generated based on operations to the electronic information board 120 while the first mobile device P1 is used as the transmission sender, and the first mobile device P1 and the second mobile device P2 are both used as the transmission destination.

At step S406, the electronic information board 120 communicates with the mail server 108 to perform a transmission process of the generated distribution mail. At step S407, the first mobile device P1 receives the distribution mail addressed to the mail address of the first mobile device P1. At step S408, the second mobile device P2 receives the distribution mail addressed to the mail address of the second mobile device P2.

In this example case, the mail address of the first mobile device P1 is set as a transmission sender of the distribution mail. At step S409, the second mobile device P2 generates a reply mail to the first mobile device P1 used as the transmission sender. At step S410, the second mobile device P2 communicates with mail server 108 to perform a transmission process of the generated reply mail. At step S411, the first mobile device P1 receives the reply mail addressed to the mail address of the first mobile device P1.

As to the electronic information board 120 according to one or more example embodiments, the electronic information board 120 can select an e-mail address of a sender that has transmitted the e-mail, or an e-mail address of a destination included in the transmitted e-mail as the transmission sender of the distribution mail. Therefore, as illustrated in FIG. 10, when the second mobile device P2 receives the distribution mail, the second mobile device P2 can transmit the reply mail to the mail address of the set transmission sender (first mobile device P1) set for the distribution mail instead of the electronic information board 120. Therefore, it is perceived that the selected e-mail address is the transmission sender of the distribution mail in appearance.

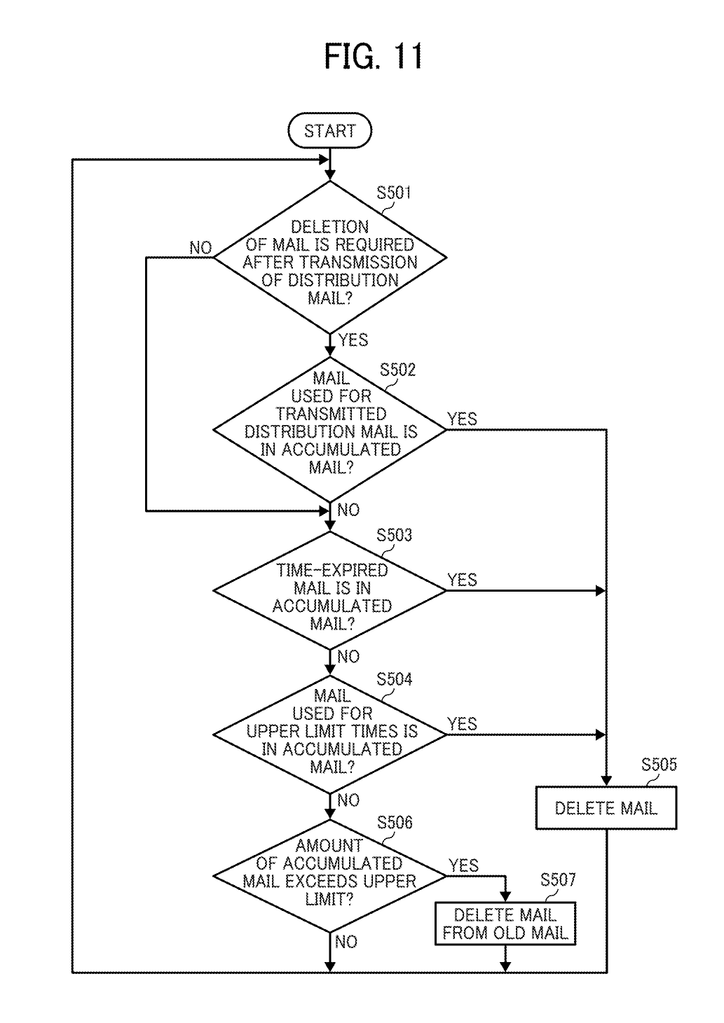

A description is given of a process of deleting a mail with reference to FIG. 11. FIG. 11 is a flowchart showing the steps of a process of deleting a mail by the electronic information board 120. The sequence of FIG. 11 can be started when the electronic information board 120 is activated. At step S501, the mail deleting unit 240 of the electronic information board 120 determines whether a deletion of the used accumulated mail is required after transmitting the distribution mail, in which whether the accumulated mail used for transmitting the distribution mail is to deleted or not after transmitting the distribution mail can be set in advance. At step S501, it is determined whether the deletion of the used accumulated mail is required based on the set information.

If it is determined that the deletion of the used accumulated mail is required after transmitting the distribution mail (S501: YES), the sequence proceeds to step S502. At step S502, the mail deleting unit 240 of the electronic information board 120 determines whether one or more accumulated mails that are already used for transmitting the distribution mail exist. For example, after transmitting the distribution mail at step S205 (FIG. 6), a flag indicating “used” can be set to the accumulated mail that was used for setting the communication settings such as transmission settings of the distribution mail, with which the mail deleting unit 240 can determine whether the concerned accumulated mail is already used. If it is determined that the accumulated mail already used for transmitting the distribution mail exist (S502: YES), the sequence proceeds to step S505. At step S505, the mail deleting unit 240 of the electronic information board 120 deletes the used mail, and then the sequence returns to step S501.

By contrast, if it is determined that the accumulated mail already used for transmitting the distribution mail does not exist (S502: NO), the sequence proceeds to step S503. Further, if it is determined that the mail deleting process after transmitting the distribution mail is not required (S501: NO), the sequence proceeds to step S503.

At step S503, the mail deleting unit 240 of the electronic information board 120 determines whether one or more accumulated mails that have elapsed a given time period after the mail reception exist. For example, information of time when a mail is received by the electronic information board 120 can be recorded as a reception time of mail when accumulating the mails. Then, the reception time of the concerned accumulated mail is compared with current time information to determine a time period from the reception time to the current time. If it is determined that the concerned accumulated mail has elapsed the given time period (S503: YES), the sequence proceeds to step S505. At step S505, the mail deleting unit 240 of the electronic information board 120 deletes the concerned mail that has elapsed the given time period, and the sequence proceeds to step S501. Further, a time limit for determining the mail deletion can be set in advance.

By contrast, if it is determined that the concerned accumulated mail does not elapse the given time period (S503: NO), the sequence proceeds to step S504. At step S504, the mail deleting unit 240 of the electronic information board 120 determines whether one or more accumulated mails that have reached the maximum threshold of use times exist. For example, after transmitting the distribution mail at step S205 of FIG. 6, a counter that counts the number of use times of the accumulated mail used for setting the communication settings such as transmission settings of the distribution mail, and increments the count number one by one, with which the mail deleting unit 240 can determine the number of use times of the concerned accumulated mail that was already used.

If it is determined that the number of use times of the concerned accumulated mail reaches the maximum threshold of use times (S504: YES), the sequence proceeds to step S505. At step S505, the mail deleting unit 240 of the electronic information board 120 deletes the concerned mail having the maximum threshold of use times, and the sequence proceeds to step S501. Further, the maximum threshold of use times of a mail can be set in advance.

By contrast, if it is determined that no accumulated mails reach the maximum threshold of use times (S504: NO), the sequence proceeds to step S506. At step S506, the mail deleting unit 240 of the electronic information board 120 determines whether the number of accumulated mails accumulated in the mail accumulator 214 reaches an upper limit. If it is determined that the number of accumulated mails reaches the upper limit (S506: YES), the sequence proceeds to step S507. At step S507, the mail deleting unit 240 of the electronic information board 120 deletes one or more mails from the accumulated mails, in which the upper limit number is subtracted from the number of accumulated mails, and one or more mails exceeding the upper limit are deleted by applying a given order such as an order of the reception time of the accumulated mails (e.g., deleting mails from the oldest mail). After step S507, the sequence returns to step S501. If it is determined that the number of accumulated mails does not reach the upper limit (S506: NO), the sequence returns to step S501, and continues the determination process.

Therefore, the accumulated mails can be deleted as required by the process shown in FIG. 11. From the viewpoint of information security policy, it is not preferable to retain information of the received mails for a longer time period. By applying the above described deleting process, the accumulated mails not preferable to be retained for the longer time period due to information security issue can be deleted as required.

As to the above described configuration, the mobile device 116 and the electronic information board 120 cannot directly communicate with each other. Therefore, the electronic information board 120 displays a two-dimensional code embedded with a coded mail address of the electronic information board 120, and the mobile device 116 reads the two-dimensional code to acquire the mail address information of the electronic information board 120.

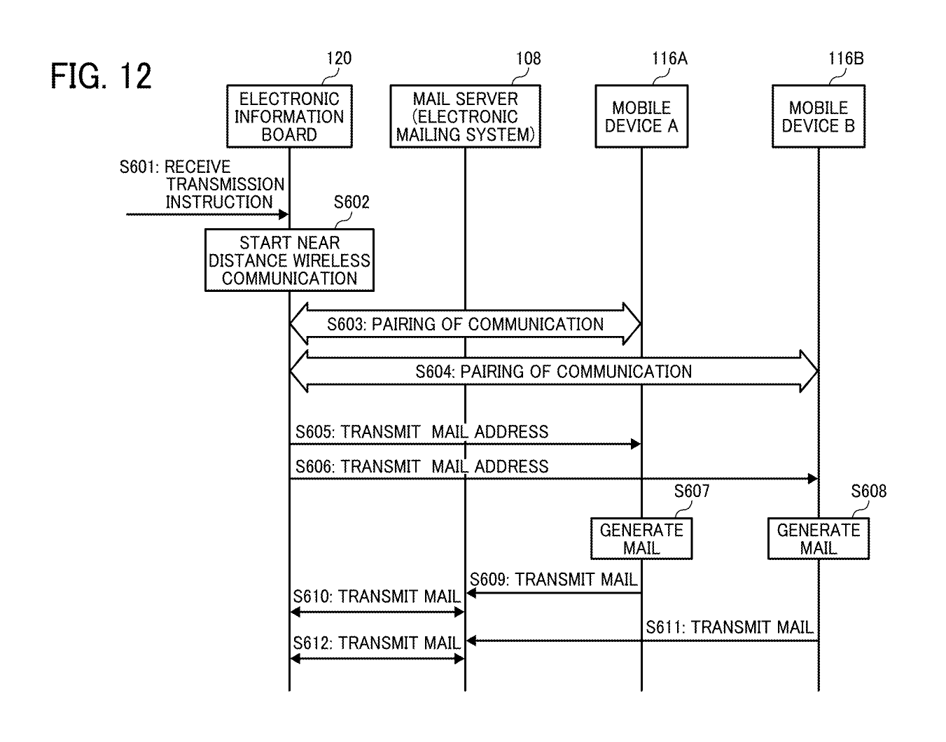

A description is now given of a process of establishing wireless communication between the mobile device 116 and the electronic information board 120 according to another example embodiment with reference to FIGS. 12 to 14.

FIG. 12 is a sequential chart of receiving a distribution mail by the mobile device 116 in a network system according to another example embodiment of, in which the mobile device 116 and the electronic information board 120 can be connected with each other via the external connection I/F 140 by using, for example, near distance wireless communication such as Bluetooth (registered trademark), and near field communication (NFC). Further, the mobile device 116 can be installed with a dedicated application, with which data transmitted from the electronic information board 120 can be processed (e.g., display of data).

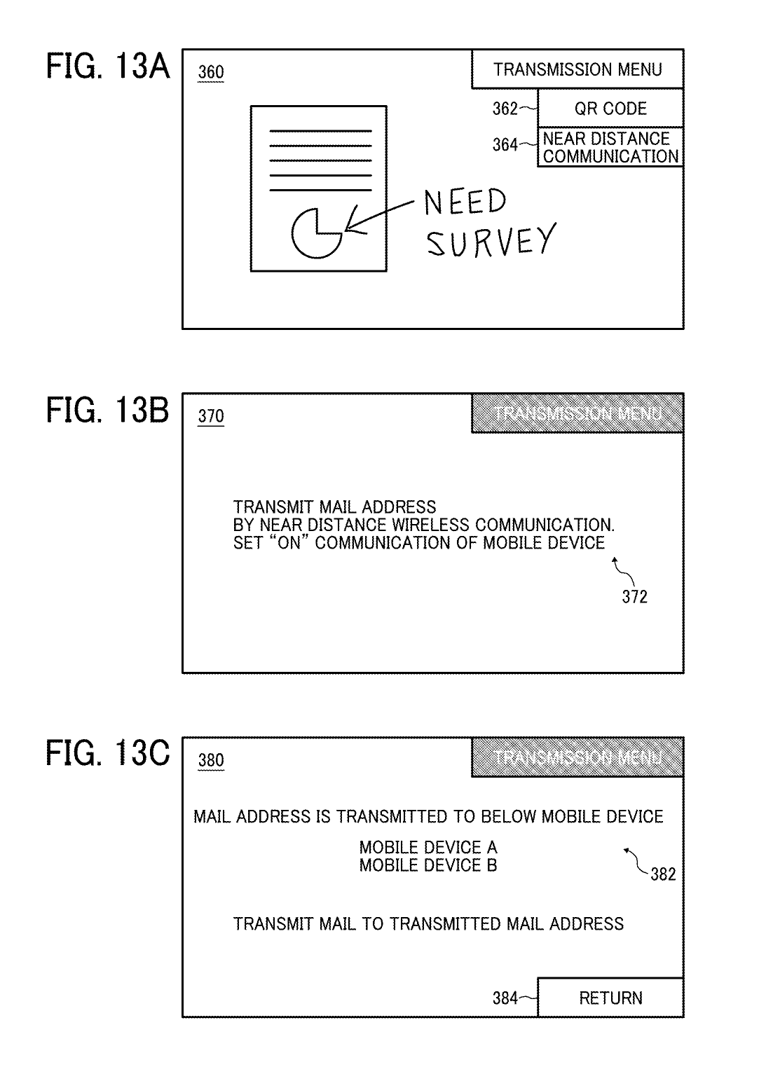

As illustrated in FIG. 12, the electronic information board 120 receives a transmission instruction of mail address from a user at step S601. For example, the electronic information board 120 displays a screen 360 shown in FIG. 13A, and the electronic information board 120 receives a selection of “transmission of mail address by near distance wireless communication 364” from a transmission menu displayed on the screen 360. Further, when “QR code” 362 is selected on the screen 360 shown in FIG. 13A, the electronic information board 120 displays the screen image shown in FIG. 5.

Referring back to FIG. 12, the electronic information board 120 starts the near distance wireless communication at step S602. When the electronic information board 120 starts the near distance wireless communication, a screen 370 including a message 372 shown in FIG. 13B can be displayed. Then, at steps S603 and S604, the electronic information board 120 performs a paring of communication with each of the mobile devices 116 existing within an area of near distance wireless communication. For example, in an example case of FIG. 12, the electronic information board 120 can be paired with the mobile device 116A and the mobile device 116B.

When the electronic information board 120 is paired with the mobile device 116A and the mobile device 116B, the electronic information board 120 can transmit a mail address to the mobile device 116A and the mobile device 116B at steps S605 and S606. When the electronic information board 120 transmits a mail address of the electronic information board 120, a screen 380 including a message 382 indicating a mail transmission result shown in FIG. 13C can be displayed. Further, when a return button 384 is pressed or touched on the screen 380, the screen 380 returns to the screen 360.

When the mobile device 116A and the mobile device 116B receive the mail address from the electronic information board 120, an application installed to the mobile device 116A displays a mail transmission screen related to the received mail address at step S607, and an application installed to the mobile device 116B displays a mail transmission screen related to the received mail address at step S608.

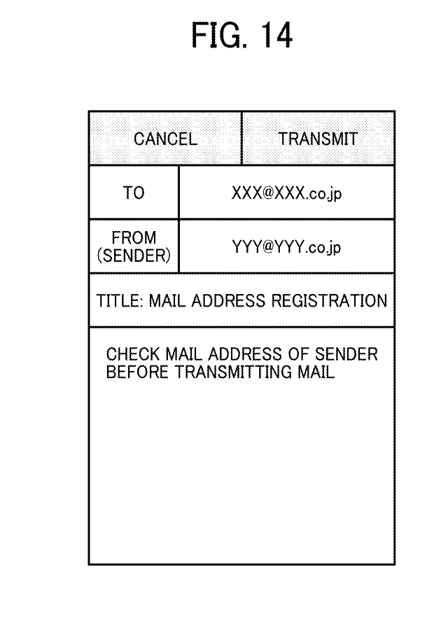

FIG. 14 is an example of a screen displayable by the mobile device 116A and the mobile device 116B. As illustrated in FIG. 14, a mail address transmitted from the electronic information board 120 is set to the “to” field, a default mail address of the mobile device 116A is set to the “sender” field, and a default mail address of the mobile device 116B is set to the “sender” field. A title, and a body can be set blank. Further, if the mobile device 116A and the mobile device 116B can select a mail address of sender from a plurality of mail addresses, the user can be alerted not to select a wrong sender mail address by displaying a message of “check mail address of sender before transmitting mail” on the screen.

When each of the mobile device 116A and the mobile device 116B receives a mail transmission instruction from a user, each of the mobile device 116A and the mobile device 116B transmits a mail to the mail address of the electronic information board 120, transmitted from the electronic information board 120, at steps S609 to S612, via the mail server 108. Then, similar to the sequential process of FIG. 4, the electronic information board 120 can further call a generation process of distribution mail in response to a user's operation, and can perform a mail transmission process to the mail server 108. For example, a distribution mail is transmitted from the electronic information board 120 to the mobile device 116A and the mobile device 116B, which have transmitted a mail to the electronic information board 120.

With this configuration, when a plurality of mail addresses corresponding to a plurality of persons is to be registered in the electronic information board 120, the mail address can be transmitted from the electronic information board 120 to each of the mobile devices 116 without an image capturing operation of a screen the electronic information board 120 by all of the persons.

As to the above described information processing apparatus, electronic information board, software program, information processing system, and electronic information board system of one or more example embodiments, when data is loaded to the information processing apparatus such as when data such as image data is displayed on a screen or a display of the information processing apparatus (e.g., electronic information board), the displayed data can be retrieved and then delivered as a message (e.g., e-mail), users can set transmission settings of the message on the information processing apparatus easily, and thereby operation works by the users for setting the transmission settings can be reduced.

As to the above described configuration, by transmitting an e-mail to the information processing apparatus (e.g., electronic information board 120) from the mobile device, users can set transmission sender information, transmission destination information, title information, and body information of a distribution mail attached with data displayed on the information processing apparatus easily based on information of the received e-mails. Therefore, the user operation on the information processing apparatus can be simplified, and thereby operation works by the user on the information processing apparatus can be reduced.

The computer software can be provided to the programmable device using any storage medium or carrier medium for storing processor-readable code such as a floppy disk, a compact disk read only memory (CD-ROM), a compact disk rewritable (CD-RW), a digital versatile disk read only memory (DVD-ROM), a DVD random access memory (DVD-RAM), DVD recording only/rewritable (DVD-R/RW), Blu-ray Disc (registered trademark), electrically erasable and programmable read only memory (EEPROM), erasable programmable read only memory (EPROM), a flash memory, a flexible disk, a memory card or stick such as USB memory, a memory chip, a secure digital (SD) card, a mini disk (MD), a magneto optical disc (MO), magnetic tape, a hard disk in a server, a solid state memory device or the like, but not limited these.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input apparatus, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C, C++, C#, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination. Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An information processing apparatus comprising:
a message receiver to receive a message;
an attachment data generator to generate attachment data to be attached to a distribution message, to be transmitted from the information processing apparatus, by retrieving data loaded to the information processing apparatus;
an extractor to extract candidate information to be used as transmission setting information of the distribution message from information included in the message received by the message receiver;
a message generator to generate the distribution message attachable with the attachment data generated by the attachment data generator based on the transmission setting information extracted by the extractor; and
a message transmitter to transmit the distribution message generated by the message generator.

2. The information processing apparatus of claim 1, wherein the extractor extracts at least one of transmission sender information, transmission destination information, title information, and body information included in the message received by the message receiver.

3. The information processing apparatus of claim 1, wherein the message generator sets at least one of transmission sender information, transmission destination information, reply-destination information, title information, and body information of the distribution message based on the transmission setting information extracted by the extractor.

4. The information processing apparatus of claim 1, further comprising:
an image information generator to generate image information embedded with destination information receivable by the information processing apparatus; and
an output unit to output the image information generated by the image information generator.

5. The information processing apparatus of claim 1, further comprising a calling unit to call the message generator when the message receiver receives the message.

6. The information processing apparatus of claim 1, wherein the attachment data generator converts the image data displayed on a display of a display apparatus, and data input to the image data displayed on the display by an input apparatus into data having a given format.

7. The information processing apparatus of claim 1, further comprising:
an accumulator to accumulate the message received by the message receiver for generating a distribution message to be transmitted from the information processing apparatus; and
a deleting unit to delete the message accumulated in the accumulator
when a transmission of the distribution message based on the received message completes,
when a given time period elapses after receiving the message,
when a number of use times of the message used for setting the transmission setting information exceeds a threshold, or
when a number of messages accumulated in the accumulator exceeds a threshold.

8. The information processing apparatus of claim 1, further comprising a selection unit to select at least one of transmission sender information, transmission destination information, and reply-destination of the distribution message from an address list.

9. The information processing apparatus of claim 1, wherein an electronic mail of an electronic mail system or an instant message of an instant messaging system is used for the message receivable by the message receiver and the distribution message transmittable by the message transmitter.

10. An electronic information board comprising:
a display apparatus to display data on a screen;
an input apparatus to input data to the screen displayable with the data; and
the information processing apparatus of claim 1.

11. A non-transitory computer-readable storage medium storing a program that, when executed by a computer, causes the computer to execute a method of processing information, the method comprising the steps of:
receiving a message;
generating attachment data to be attached to a distribution message, to be transmitted from an information processing apparatus, by retrieving data loaded to the information processing apparatus;
extracting candidate information to be used as transmission setting information of the distribution message based on the received message;
generating the distribution message attachable with the generated attachment data based on the extracted transmission setting information; and
transmitting the generated distribution message.

12. An information processing system, comprising:
an information processing apparatus; and
an information terminal device including
a message transmitter to transmit a message by designating a destination receivable by the information processing apparatus,
wherein the information processing apparatus includes:
a message receiver to receive the message transmitted from the message transmitter of the information terminal device;
an attachment data generator to generate attachment data to be attached to a distribution message, to be transmitted from the information processing apparatus, by retrieving data loaded to the information processing apparatus;
an extractor to extract candidate information to be used as transmission setting information of the distribution message from information included in the message received by the message receiver;
a message generator to generate the distribution message attachable with the attachment data generated by the attachment data generator based on the transmission setting information extracted by the extractor; and
a message transmitter to transmit the distribution message generated by the message generator.

13. The information processing system of claim 12,
wherein the information processing apparatus further includes:
an image information generator to generate image information embedded with destination information receivable by the information processing apparatus; and
an output unit to output the image information generated by the image information generator,
wherein the information terminal device further includes:
a reader to read the image information output by the output unit of the information processing apparatus;
an extractor to extract destination information from the image information read by the reader; and
a generator to generate a message addressed to the extracted destination information.
